(19) United States
(12) Patent Application Publication
(10) Pub. No.: US 2026/0158836 A1
(43) Pub. Date: Jun. 11, 2026

(54) Vehicle Protector For Use With A Tow Line

(71) Applicant: Matthew Farrell, Golden Valley, AZ (US)

(72) Inventor: Matthew Farrell, Golden Valley, AZ (US)

(21) Appl. No.: 18/969,505

(22) Filed: Dec. 5, 2024

(51) Int. Cl. B60D 1/24; B60D 1/18

(52) U.S. Cl. CPC B60D 1/24; B60D 1/18

(57) ABSTRACT

A protective apparatus for preventing collisions between a towing line and a vehicle in the event the towing line breaks while under tension includes a frame which defines an aperture for receiving the towing line that extends between a towing vehicle and a towed vehicle. A front shielding member and a back shielding member are attached to the frame. When positioned in a use configuration, the front shielding member extends forwardly from the frame and the back shielding member extends backwardly from the frame. The front and back shielding members extend over the towing line in the use configuration and attach to the towing vehicle and the towed vehicle respectively. If the towing line snaps while under tension, the front and back shielding members prevent the towing line from moving upwardly toward one of the vehicles.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to towing safety apparatuses and more particularly pertains to a new towing safety apparatus for preventing collisions between a towing line and a vehicle in the event the towing line breaks while under tension.

### (2) Description of Related Art including information disclosed under 37 CFR 1.97 and 1.98.

The prior art relates to towing safety apparatuses such as bumpers and shields which protect vehicles from rocks and other debris. Some such apparatuses are employed with a tow bar or similar mechanism to protect either or both of a towing vehicle and a towing vehicle from such debris. However, the prior art fails to describe such an apparatus which extends over a flexible tow line such that the tow line is prevented from moving upwardly toward one of the vehicles upon breaking under tension.

### (h) BRIEF SUMMARY OF THE INVENTION

An embodiment of the disclosure meets the needs presented above by generally comprising a frame which defines an aperture that extends through a front side and a back side of the frame. The aperture has a size such that the aperture is configured to receive a towing line which extends between a towing vehicle and a towed vehicle. A front shielding member and a back shielding member are coupled to the frame. The front and back shielding members are positionable in a use configuration in which the front shielding member extends forwardly from the frame and the back shielding member extends backwardly from the frame. The front and back shielding members are configured to extend over the towing line when in the use configuration such that the front and back shielding members are configured for inhibiting movement of the towing line if the towing line breaks while under tension. A front mounting assembly is coupled to the front shielding member and is configured to mount the front shielding member to the towing vehicle. A back mounting assembly is coupled to the back shielding member and is configured to mount the back shielding member to the towed vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(s)

The disclosure will be better understood and objects other than those set forth above will become apparent when consideration is given to the following detailed description thereof. Such description makes reference to the annexed drawings wherein:

FIG. 1 is a front detail perspective view of a frame of a protective apparatus according to an embodiment of the disclosure.

FIG. 2 is a rear detail perspective view of a frame of an embodiment of the disclosure without surrounding components of the embodiment shown. A gate of the frame is shown in a closed position.

FIG. 3 is a front detail perspective view of a frame of an embodiment of the disclosure without surrounding components of the embodiment shown. A gate of the frame is shown in an open position.

FIG. 4 is a rear detail view of a frame of an embodiment of the disclosure.

FIG. 5 is a side detail view of a frame of an embodiment of the disclosure.

FIG. 6 is a top view of an embodiment of the disclosure.

FIG. 7 is a top in-use view of an embodiment of the disclosure.

FIG. 8 is a side in-use view of an embodiment of the disclosure.

### (j) DETAILED DESCRIPTION OF THE INVENTION

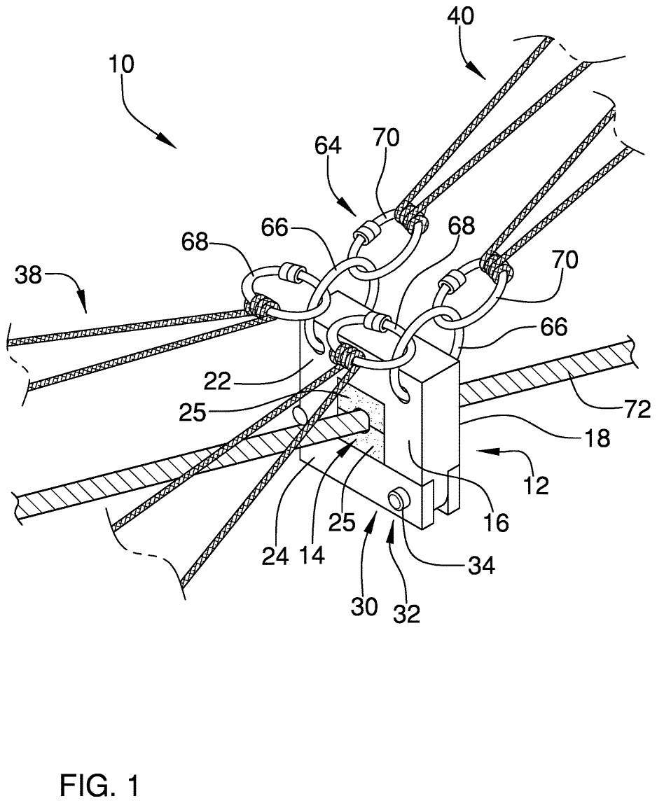

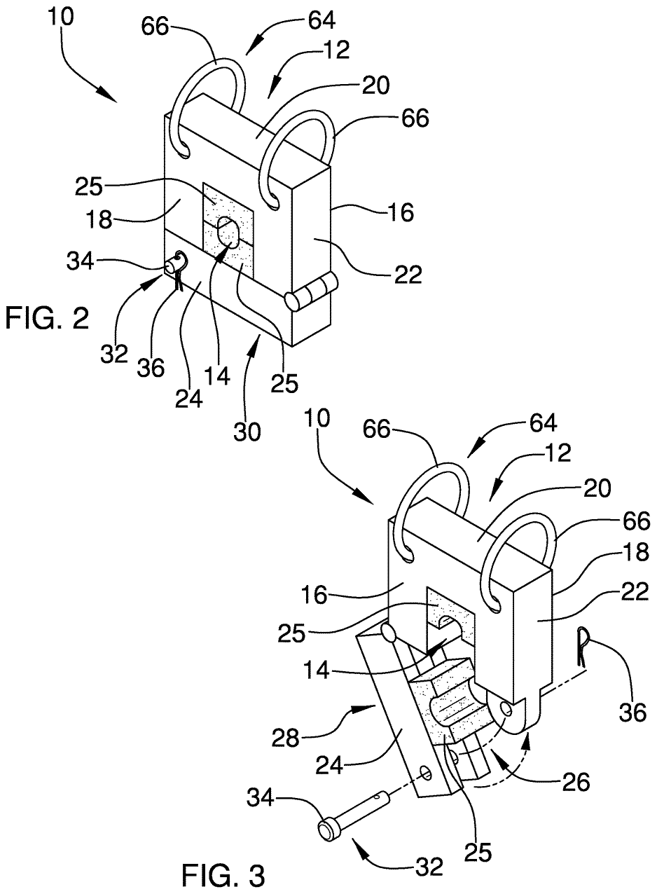

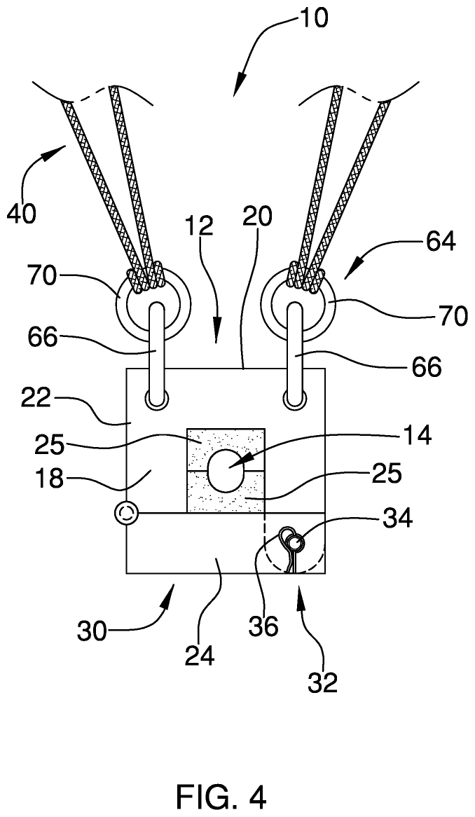

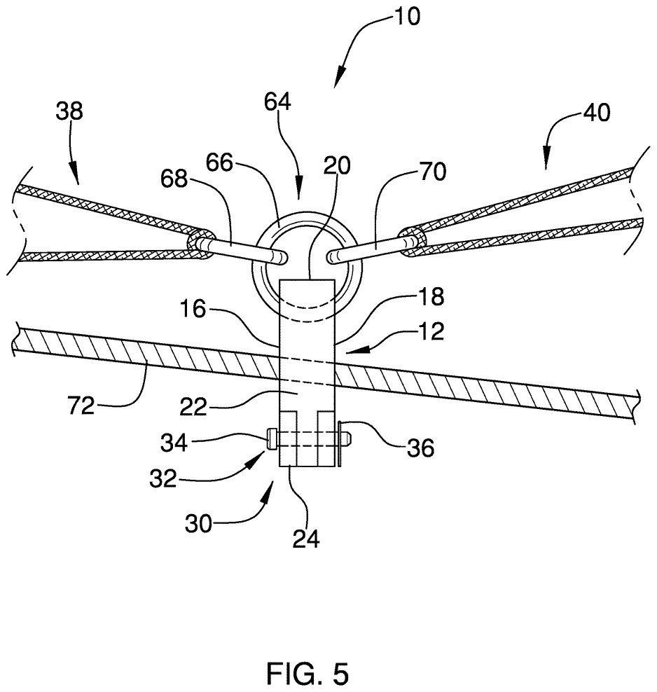

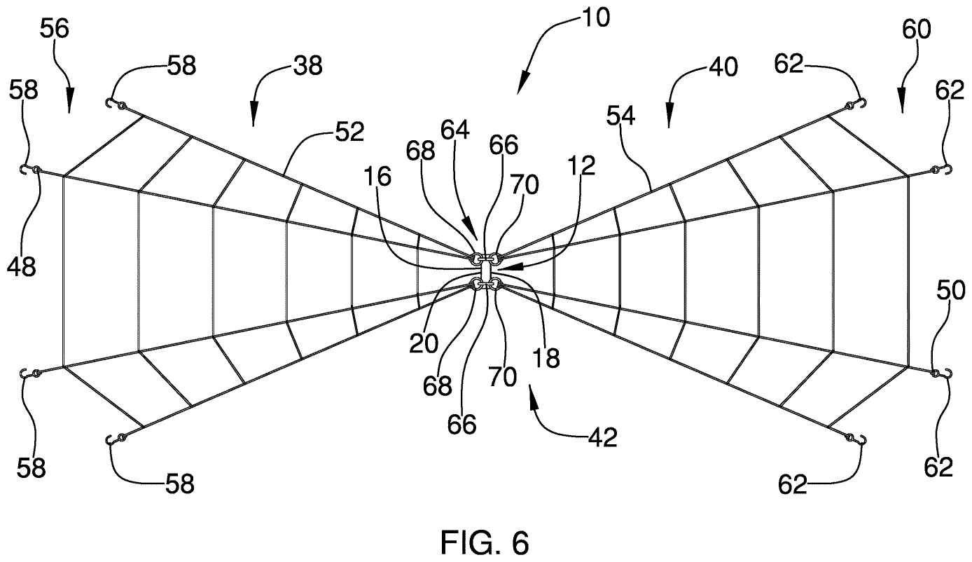

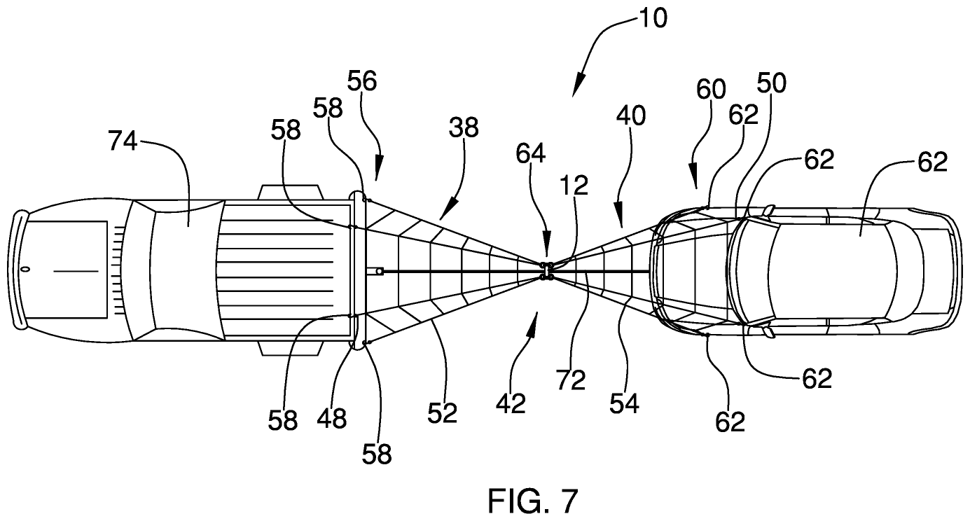

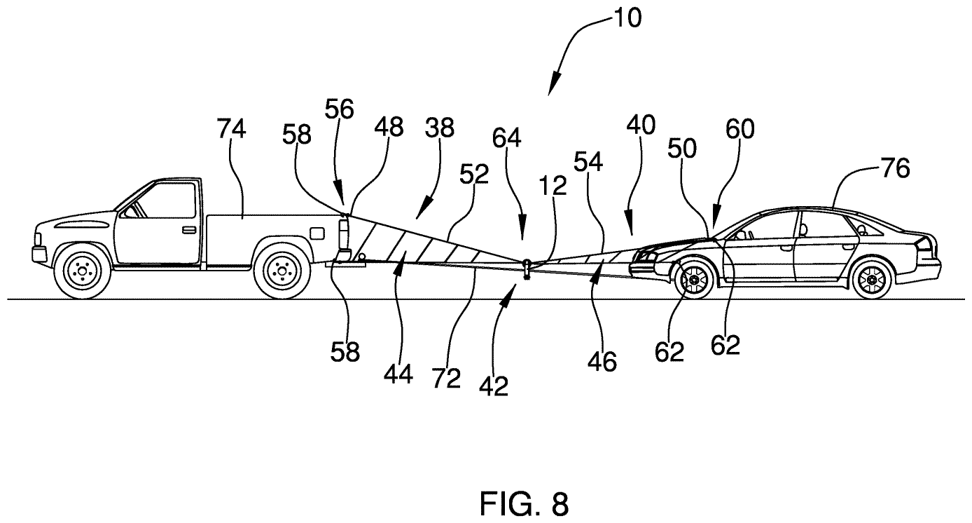

With reference now to the drawings, and in particular to FIGS. 1 through 8 thereof, a new towing safety apparatus embodying the principles and concepts of an embodiment of the disclosure and generally designated by the reference numeral 10 will be described.

As best illustrated in FIGS. 1 through 8, the protective apparatus 10 generally comprises a frame 12 which defines an aperture 14 that extends through a front side 16 and a back side 18 of the frame 12. The aperture 14 has a size such that the aperture 14 is configured to receive a towing line 72. The frame 12 comprises a main portion 22 and a gate 24, wherein the gate 24 is movably coupled to the main portion 22. The gate 24 is pivotable between an open position 28 and a closed position 30 such that the gate 24 defines an opening 26 to the aperture 14 when positioned in the open position 28 and covers the opening 26 when in the closed position 30. A gate locking member 32 is releasably engageable with the gate 24 and the main portion 22 of the frame 12 to secure the gate 24 in the closed position 30. The gate locking member 32 comprises a locking pin 34 and a retaining pin 36, wherein the locking pin 34 is insertable through the gate 24 and the main portion 22 of the frame 12, and the retaining pin 36 is insertable through the locking pin 34 to abut the frame 12 and retain the locking pin 34 to the frame 12. In some embodiments, the gate 24 may be slidable or otherwise movable respectively to the main portion 22 of the frame 12 to open and close the opening 26. The gate 24 may screw onto the main portion 22 or attach via other fasteners such as a latch, a clasp, a clamp, or the like when in the closed position 30 in other embodiments.

The frame 12 further comprises a pair of jaws 25, each of which is mounted in the aperture 14 to a respective one of the main portion 22 and the gate 24. The jaws 25 are sized and shaped to clamp the towing line 72 when the gate 24 is in the closed position 30. Each jaw 25 of the pair of jaws 25 comprises a resiliently deformable material such that the pair of jaws 25 conform to an outer surface of the towing line 72. The resiliently deformable material may be, for example, rubber, silicone, or the like.

A front shielding member 38 and a back shielding member 40 are coupled to the frame 12. The front and back shielding members 38, 40 are positionable in a use configuration 42 in which the front shielding member 38 extends forwardly from the frame 12 and the back shielding member 40 extends backwardly from the frame 12. When in the use configuration 42 and the frame 12 receives the towing line 72 through the aperture 14, the front and back shielding members 38, 40 extend over the towing line 72 in order to inhibit movement of the towing line 72 if the towing line 72 breaks. In some embodiments, the front and back shielding members 38, 40 may surround the towing line 72 on multiple sides. Each one of the front and back shielding members 38, 40 is positionable to define a concavity 44, 46 over the towing line 72 when in the use configuration 42. Each one of the front and back shielding members 38, 40 tapers toward the frame 12 when in the use configuration 42. Each one of the front and back shielding members 38, 40 comprises a net 52, 54. In other embodiments, other flexible members such as tarps, other fabric materials, or the like may be used for the front and back shielding members 38, 40. Rigid members such as wood panels, sheet metal, rigid plastics, or the like may be used in some embodiments. Notably, nets and other structures with through holes enable the front and back shielding members 38, 40 to catch the towing line 72 via entanglement with the towing line 72.

A front mounting assembly 56 is coupled to the front shielding member 38 and is configured to mount the front shielding member 38 to a towing vehicle 74 which tows a towed vehicle 76 via the towing line 72. The front mounting assembly 56 comprises a plurality of front hooks 58 coupled to a distal end 48 of the front shielding member 38 with respect to the frame 12. A back mounting assembly 60 is coupled to the back shielding member 40 and is configured to mount the back shielding member 40 to the towed vehicle 76. The back mounting assembly 60 comprises a plurality of back hooks 62 coupled to a distal end 50 of the back shielding member 40 with respect to the frame 12. In some embodiments, the front and back mounting assemblies may comprise magnetic connectors, straps, adhesives, or other suitable fasteners for attaching to the towing vehicle 74 and the towed vehicle 76 respectively.

A frame connector assembly 64 couples the front and back shielding members 38, 40 to the frame 12. The frame connector assembly 64 comprises a pair of frame rings 66, a pair of front rings 68, and a pair of back rings 70. The frame rings 66 are mounted to the frame 12 and positioned on a top side 20 of the frame 12. The frame rings 66 are laterally spaced from each other with respect to the frame 12. The front rings 68 are coupled to the front shielding member 38, and each front ring 68 interlocks with an associated frame ring 66 of the pair of frame rings 66. The back rings 70 are coupled to the back shielding member 40, and each back ring 70 interlocks with an associated frame ring 66 of the pair of frame rings 66. The front rings 68 and the back rings 70 may be detachable from the frame rings 66 in some embodiments to facilitate disassembly of the protective apparatus 10 for storage or replacement of parts. One or more of the frame rings 66, the front rings 68, and the back rings 70 may comprise a carabiner, a quick link, or the like to facilitate such disconnection.

In use, when using the towing line 72 to tow the towed vehicle 76 via the towing vehicle 74, the frame 12 may be positioned to receive the towing line 72 through the aperture 14 of the frame 12. This may be done, for example, by threading the towing line 72 through the aperture 14 before attaching the towing line 72 to both the towing vehicle 74 and the towed vehicle 76 or by opening 26 the gate 24 of the frame 12 to receive the towing line 72 through the opening 26 after the towing line 72 is already secured on both of its ends. Then the front and back shielding members 38, 40 are attached to the towing vehicle 74 and the towed vehicle 76 respectively in the use configuration 42 such that the front and back shielding members 38, 40 extend over the towing line 72. The front hooks 58 and back hooks 62 may be attached to tailgates, wheel wells, hood edges, or the like on the towing vehicle 74 and the towed vehicle 76.

In the embodiment shown in the figures, the front and back shielding members 38, 40 form concavities 44, 46 over the towing line 72. Should the towing line 72 break and be urged into one of the concavities 44, 46, the shape of either the front shielding member 38 or the back shielding member 40 may act to direct the towing line 72 further into the concavity 44, 46, rather than causing the towing line 72 to rebound away as would be more likely should such components have planar or convex surfaces facing the towing line 72. Such concave formations are facilitated by the front and back shielding members 38, 40 having flexible materials (e.g., the nets 52, 54 shown), or by having rigid components which form such concavities 44, 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A protective apparatus for use with a towing vehicle and a towed vehicle, the protective apparatus comprising:
a frame defining an aperture which extends through a front side and a back side of the frame, the aperture having a size such that the aperture is configured to receive a towing line;
a front shielding member and a back shielding member coupled to the frame, the front and back shielding members being positionable in a use configuration in which the front shielding member extends forwardly from the frame and the back shielding member extends backwardly from the frame, the front and back shielding members being configured to extend over the towing line when in the use configuration such that the front and back shielding members are configured for inhibiting movement of the towing line if the towing line breaks;
a front mounting assembly coupled to the front shielding member and configured to mount the front shielding member to the towing vehicle; and
a back mounting assembly coupled to the back shielding member and configured to mount the back shielding member to the towed vehicle.

2. The protective apparatus of claim 1, wherein the frame comprises a main portion and a gate, the gate being movably coupled to the main portion, the gate being pivotable between an open position and a closed position, the gate defining an opening to the aperture when positioned in the open position, the gate covering the opening when in the closed position.

3. The protective apparatus of claim 2, further comprising a gate locking member releasably engageable with the gate and the main portion of the frame to secure the gate in the closed position.

4. The protective apparatus of claim 3, wherein the gate locking member comprises a locking pin and a retaining pin, the locking pin being insertable through the gate and the main portion of the frame, the retaining pin being insertable through the locking pin to abut the frame and retain the locking pin to the frame.

5. The protective apparatus of claim 1, wherein each one of the front and back shielding members tapers toward the frame when in the use configuration.

6. The protective apparatus of claim 1, wherein each one of the front and back shielding members is positionable to be configured to define a concavity over the towing line when in the use configuration.

7. The protective apparatus of claim 1, wherein each one of the front and back shielding members comprises a net.

8. The protective apparatus of claim 1, wherein the front mounting assembly comprises a plurality of front hooks coupled to a distal end of the front shielding member with respect to the frame.

9. The protective apparatus of claim 1, wherein the back mounting assembly comprises a plurality of back hooks coupled to a distal end of the back shielding member with respect to the frame.

10. The protective apparatus of claim 1, further comprising a frame connector assembly coupling the front and back shielding members to the frame, the frame connector assembly comprising:
a pair of frame rings mounted to the frame, the pair of frame rings being positioned at a top side of the frame, the pair of frame rings being laterally spaced from each other with respect to the frame;
a pair of front rings coupled to the front shielding member, each front ring of the pair of front rings interlocking with an associated frame ring of the pair of frame rings; and
a pair of back rings coupled to the back shielding member, each back ring of the pair of back rings interlocking with an associated frame ring of the pair of frame rings.

11. The protective apparatus of claim 1, wherein the frame further comprises a pair of jaws, each jaw of the pair of jaws being mounted in the aperture to a respective one of the main portion and the gate, the jaws being configured to clamp the towing line when the gate is in the closed position.

12. The protective apparatus of claim 11, wherein each jaw of the pair of jaws comprises a resiliently deformable material such that the pair of jaws conform to an outer surface of the towing line

13. A protective apparatus for use with a towing vehicle and a towed vehicle, the protective apparatus comprising:
a frame defining an aperture which extends through a front side and a back side of the frame, the aperture having a size such that the aperture is configured to receive a towing line, the frame comprising a main portion and a gate, the gate being movably coupled to the main portion, the gate being pivotable between an open position and a closed position, the gate defining an opening to the aperture when positioned in the open position, the gate covering the opening when in the closed position, the frame further comprising a pair of jaws, each jaw of the pair of jaws being mounted in the aperture to a respective one of the main portion and the gate, the jaws being configured to clamp the towing line when the gate is in the closed position, each jaw of the pair of jaws comprising a resiliently deformable material such that the pair of jaws conform to an outer surface of the towing line;
a gate locking member releasably engageable with the gate and the main portion of the frame to secure the gate in the closed position, the gate locking member comprising a locking pin and a retaining pin, the locking pin being insertable through the gate and the main portion of the frame, the retaining pin being insertable through the locking pin to abut the frame and retain the locking pin to the frame;
a front shielding member and a back shielding member coupled to the frame, the front and back shielding members being positionable in a use configuration in which the front shielding member extends forwardly from the frame and the back shielding member extends backwardly from the frame, the front and back shielding members being configured to extend over the towing line when in the use configuration such that the front and back shielding members are configured for inhibiting movement of the towing line if the towing line breaks, each one of the front and back shielding members tapering toward the frame when in the use configuration, each one of the front and back shielding members being positionable to be configured to define a concavity over the towing line when in the use configuration, each one of the front and back shielding members comprising a net;
a front mounting assembly coupled to the front shielding member and configured to mount the front shielding member to the towing vehicle, the front mounting assembly comprising a plurality of front hooks coupled to a distal end of the front shielding member with respect to the frame;
a back mounting assembly coupled to the back shielding member and configured to mount the back shielding member to the towed vehicle, the back mounting assembly comprising a plurality of back hooks coupled to a distal end of the back shielding member with respect to the frame; and
a frame connector assembly coupling the front and back shielding members to the frame, the frame connector assembly comprising:
a pair of frame rings mounted to the frame, the pair of frame rings being positioned at a top side of the frame, the pair of frame rings being laterally spaced from each other with respect to the frame;
a pair of front rings coupled to the front shielding member, each front ring of the pair of front rings interlocking with an associated frame ring of the pair of frame rings; and
a pair of back rings coupled to the back shielding member, each back ring of the pair of back rings interlocking with an associated frame ring of the pair of frame rings.
